(19) United States
(12) Patent Application Publication
(10) Pub. No.: US 2006/0170350 A1
(43) Pub. Date: Aug. 3, 2006

(54) Plasma display panel(PDP)

(76) Inventors: Ki-Jung Kim, Suwon-si (KR); Tae-Kyoung Kang, Suwon-si (KR)

Correspondence Address: Robert E. Bushnell, Suite 300, 1522 K Street, N.W., Washington, DC, 20005-1202, US

(21) Appl. No.: 11/327,313

(22) Filed: Jan. 9, 2006

(30) Foreign Application Priority Data
Jan. 28, 2005 (KR) 10-2005-0007991

(51) Int. Cl. H01J 17/49

(52) U.S. Cl. 313/582; 313/586

(57) ABSTRACT

A Plasma Display Panel (PDP) includes: a front substrate and a rear substrate facing each other; a plurality of barrier ribs arranged between the front substrate and the rear substrate, defining a plurality of discharge cells where a discharge occurs, and including a plurality of recesses; a plurality of electrodes corresponding to the discharge cells and adapted to generate the discharge; a plurality of phosphor layers arranged within the discharge cells; and a discharge gas contained within the discharge cells.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on 28 Jan. 2005 and there duly assigned Serial No. 10-2005-0007991.

### BACKGROUND OF THE INVENTION

1. Field of the Invention

The present invention relates to a Plasma Display Panel (PDP), and more particularly, to a PDP capable of reducing noise generated when driving the panel.

2. Description of the Related Art

In general, Plasma Display Panels (PDPs) are flat panel displays displaying an image using a gas discharge, and are considered to be the next generation of flat panel displays due to high display properties such as display capacity, brightness, contrast, residual image, and viewing angle.

In a PDP, direct current (DC) voltage or alternating current (AC) voltage applied between electrodes causes a discharge in a discharge cell containing a discharge gas, and ultraviolet rays generated by the discharge gas excite phosphor materials to emit visible light, thereby displaying images.

The PDP adopts a discharge mechanism which emits the light by applying high voltage in the discharge cell to cause the discharge as a light emission unit, and thus, shockwaves caused by the discharge are generated in the discharge cell. The shockwaves collide with inner surfaces of the discharge cell to generate vibration, and the vibration causes noise. If the noise is not reduced, product quality and competitive power of the PDP that is mainly used as a home display apparatus may be degraded.

### SUMMARY OF THE INVENTION

The present invention provides a Plasma Display Panel (PDP) capable of reducing noise.

According to an aspect of the present invention, a Plasma Display Panel (PDP) is provided including: a front substrate and a rear substrate facing each other; a plurality of barrier ribs arranged between the front substrate and the rear substrate, defining a plurality of discharge cells where a discharge occurs, and including a plurality of recesses; a plurality of electrodes corresponding to the discharge cells and adapted to generate the discharge; a plurality of phosphor layers arranged within the discharge cells; and a discharge gas contained within the discharge cells.

The recesses of the barrier ribs are preferably arranged in surfaces of the barrier ribs facing the front substrate. The recesses of the barrier ribs are alternatively preferably arranged in surfaces of the barrier ribs facing the rear substrate.

The barrier ribs preferably include horizontal barrier ribs arranged in a first direction, and vertical barrier ribs arranged in a second direction crossing the horizontal barrier ribs.

A width of the horizontal barrier ribs is preferably greater than a width of the vertical barrier ribs.

The recesses are preferably arranged in the horizontal barrier ribs. The recesses are preferably arranged in cross portions of the horizontal barrier ribs where the horizontal barrier ribs and the vertical barrier ribs intersect.

A cross-section of each recess is preferably circular shaped with respect to a surface parallel to the front substrate. A cross-section of each recess is alternatively preferably oval shaped with respect to a surface parallel to the front substrate.

The electrodes preferably include a plurality of sustain electrodes extending in a predetermined direction, and a plurality of address electrodes extending to cross the sustain electrodes. The sustain electrodes are preferably supported by the front substrate, and the address electrodes are supported by the rear substrate.

The PDP preferably further includes: a front dielectric layer supported by the front substrate and adapted to cover the sustain electrodes; and a rear dielectric layer arranged on the rear substrate and adapted to cover the address electrodes.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a Plasma Display Panel (PDP) according to a first embodiment of the present invention;

FIG. 2 is a plan view of the contraction of barrier ribs and the performances of recesses during a baking process of a rear panel of the PDP according to the first embodiment of the present invention;

FIG. 3 is a plan view of where vibration occurs in the barrier ribs and the recesses in the PDP according to the first embodiment of the present invention; and

FIG. 4 is an exploded perspective view of a PDP according to a second embodiment of the present invention.

### DETAILED DESCRIPTION OF THE INVENTION

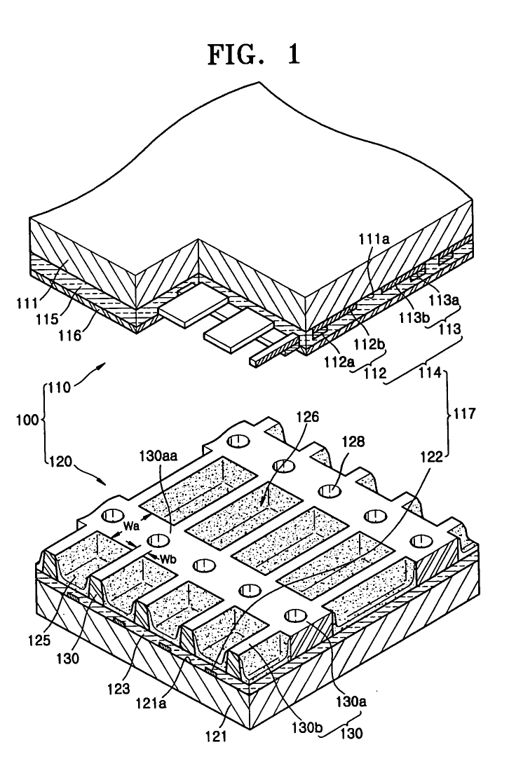

A Plasma Display Panel (PDP) 100 according to a first embodiment of the present invention is described below with reference to FIGS. 1 through 3.

The PDP 100 includes a front panel 110 and a rear panel 120. The front panel 110 includes a transparent front substrate 111 that is formed of soda-glass, and the rear panel 120 includes a rear substrate 121 facing the front substrate 111.

The front substrate 111 can be formed of a transparent soda-glass so that visible light generated by phosphor layers 125 that will be described later is transmitted therethrough. However, the rear substrate 121 does not need to be transparent since it is not located on a light path, through which the visible light proceeds. Therefore, although the rear substrate 121 can be formed of glass, it can also be formed of an opaque material such as metal or plastic.

The rear panel 120 includes a plurality of barrier ribs 130 supported by the rear substrate 121 and defining a plurality of discharge cells 126 between the front substrate 111 and the rear substrate 121. A plurality of recesses 128 are formed on at least a part of the front surface of the barrier ribs 130. The recesses 128 prevent the barrier rib material from being lifted due to the contraction of the material when the barrier ribs 130 are baked, and prevent the vibration caused by shockwaves from being transferred along the barrier ribs 130. The recesses 128 will be described in more detail later.

The barrier ribs 130 can be formed of one of a group of glass materials including Pb, B, Si, Al, and O, and if necessary, a filler such as ZrO₂, TiO₂, and Al₂O₃, and a pigment such as Cr, Cu, Co, Fe, and TiO₂.

The barrier ribs 130 can be formed using a sand blasting process, that is, a paste including the barrier rib material is applied onto an entire surface of the rear substrate 121 or an entire surface of a rear dielectric layer 123 that will be described later, a mask pattern is disposed onto the paste, and parts that are not blocked by the mask pattern are removed by accelerated blasting particles.

The barrier ribs 130 can also be formed using a photolithography process in which a predetermined shape is formed by exposing and developing the paste that includes a photosensitive material.

The barrier ribs 130 must provide at least a predetermined strength, and to ensure this, the barrier ribs 130 are baked at a temperature of about 400° C.˜600° C. A volatile material of the barrier rib material is volatilized during the baking process, and the barrier rib material contracts. The contraction problem is exacerbated when the baking process is performed after patterning the barrier rib material using the sand blasting process or the photolithography process. Such problems will be described later.

The front panel 110 includes a plurality of electrodes 117 disposed between the front substrate 111 and the rear substrate 121. The electrodes 117 can include a plurality of sustain electrodes 114 extending in a predetermined direction and a plurality of address electrodes 122 extending in a direction perpendicular to the direction in which the sustain electrodes 114 extend and crossing the sustain electrodes 114 at the discharge cells 126.

It is preferable that the sustain electrodes 114 are supported by the rear surface of the front substrate 111. However, the present invention is not limited to such as structure. The sustain electrodes 114 can be disposed on a front surface of an additional layer, such as a reflective layer reflecting visible light or a reflective layer reflecting ultraviolet rays, that is disposed on the front surface of the front substrate 111. Otherwise, the sustain electrodes 114 can be disposed on the front surface of the front substrate 111 and can be covered by a protective layer.

The sustain electrodes 114 includes a plurality of X electrodes 113 and a plurality of Y electrodes 112 extending parallel to each other and supported by the front substrate 111. The Y electrodes 112 and the X electrodes 113 are disposed on the light path, and thus, it is preferable that the X electrodes 113 and Y electrodes 112 respectively include transparent electrodes 113b and 112b formed of Indium Tin Oxide (ITO) for transmitting the visible light.

The transparent electrodes 112b and 113b generally have high resistances, and thus, an uneven electric field can be formed in the discharge cells 126 of a large size panel. Therefore, in order to form a uniform electric field in the discharge cells 126, the X electrodes 113 and the Y electrodes 112 can include bus electrodes 113a and 112a formed of high conductivity metals, for example, copper or silver.

The bus electrodes 112a and 113a can also be formed of various inexpensive high conductivity metals, such as aluminum, copper, or chrome.

The barrier ribs 130 include a plurality of horizontal barrier ribs 130a disposed in the direction in which the sustain electrodes 114 extend, and a plurality of vertical barrier ribs 130b disposed in a direction perpendicular to the direction in which horizontal barrier ribs 130a extend.

The discharge cells 126 forming unit pixels of the PDP 100 are defined by the horizontal barrier ribs 130a and the vertical barrier ribs 130b. Referring to FIG. 1, the discharge cells 126 are defined as being of rectangular shape. However, the shape of the discharge cells is not limited thereto, but can be other polygonal, or circular shapes. In addition, even if the discharge cells 126 are formed to be rectangular, the corners thereof are rounded during the baking process.

The bus electrodes 112a and 113a can extend in a direction in which the horizontal barrier ribs 130a extend. When an electrical signal, that is, an electrical potential is supplied to the bus electrodes 113a and 112a, the electrical potential is transferred to the transparent electrodes 113b and 112b that are electrically connected to the bus electrodes 113a and 112a, and thus, an electric field is formed in the discharge cells 126 by the transparent electrodes 113b and 112b which are arranged within the discharge cell 126.

In addition, it is preferable that the bus electrodes 112a and 113a are disposed between the horizontal barrier ribs 130a and the front substrate 111 since the bus electrodes 112a and 113a are formed of opaque materials. Therefore, if the bus electrodes 112a and 113a are not located on the horizontal barrier ribs 130a, the bus electrodes 112a and 113a prevent the visible light from passing therethrough, and the brightness of the PDP 100 is reduced.

As described above, when the bus electrodes 112a and 113a are disposed on the horizontal barrier ribs 130a, the X electrodes 113 and the Y electrodes 112 are arranged at every discharge cell 126. Therefore, two bus electrodes are located on each horizontal barrier rib 130a. In order to ensure a predetermined distance between the bus electrodes, it is preferable that a width Wa of the horizontal barrier ribs 130a is greater than a width Wb of the vertical barrier ribs 130b.

In addition, when the barrier ribs 130 include the horizontal barrier ribs 130a and the vertical barrier ribs 130b, the recesses 128 can be formed on the front surface of the horizontal barrier ribs 130a, and more preferably, the recesses 128 can be formed on a cross portion 130aa of the horizontal barrier ribs 130a where the horizontal barrier ribs 130a and the vertical barrier ribs 130b intersect. The recesses 128 will be described in more detail later.

The front panel 110 can further include a front dielectric layer 15 supported by the front substrate 111 for covering the sustain electrodes 114 including the bus electrodes 112a and 113a and the transparent electrodes 112b and 113b.

When the electric field is formed in the discharge cells 126 and charged particles are accelerated by the electrical potential supplied to the sustain electrodes 114, the front dielectric layer 115 prevents the accelerated charged particles from directly colliding with surfaces of the sustain electrodes 114, thereby prolonging the lifespan of the sustain electrodes 114.

In addition, wall charges can be accumulated on an upper surface of the front dielectric layer 115 during the address discharge that will be described later, and the accumulated wall charges can be used in the sustain discharge process, and the electrical potential that must be supplied during the sustain discharge process can be reduced.

In addition, since the front dielectric layer 115 is located on the light path, it is preferable that the front dielectric layer 115 is formed of a transparent dielectric material.

In addition, the PDP 100 can further include a protective layer 116 on the discharge cells 126 to cover the front dielectric layer 115.

The protective layer 116 protects the front dielectric layer 115 and the sustain electrodes 114 covered by the front dielectric layer 115, and emits secondary electrons when the charged particles collide therewith to prompt the discharge. The protective layer 116 can be formed of MgO.

The rear panel 120 includes address electrodes 122 formed of a conductive material such as copper, silver, and chrome and extending in a direction perpendicular to the direction in which sustain electrodes 114 extend. It is preferable that the address electrodes 122 are supported by the rear substrate 121. The address electrodes 122 are supported in the similar way as the sustain electrodes 114.

The address electrodes 122 can be formed using a screen printing process or a photolithography process that is used to form the sustain electrodes 114 to have predetermined shapes, and can be disposed on the rear substrate 121.

The rear panel 120 can further include a rear dielectric layer 123 supported by the rear substrate 121 so as to cover the address electrodes 122. Even if the rear dielectric layer 123 is not included, the PDP 100 can still be driven according to the present invention. However, when the accelerated charged particles directly collide with the address electrodes 122, the address electrodes 122 can be damaged, and in particular, the address electrodes 122 can be damaged by accelerated polishing particles or etchant during the process of forming the barrier ribs 130. Therefore, it is preferable that the rear panel 120 includes the rear dielectric layer 123 to protect the address electrodes 122.

The rear panel 120 includes phosphor layers 125 disposed in the discharge cells 126, that is, in spaces defined by the rear substrate 121, the horizontal barrier ribs 130a, and the vertical barrier ribs 130b.

The discharge cells 126 can be red discharge cells, green discharge cells, and blue discharge cells according to the colors of phosphor layers 125 disposed thereon, in order to realize a full-color image on the PDP 100.

In the current embodiment of the present invention, the phosphor layers 125 disposed in the red discharge cells, green discharge cells, and blue discharge cells are red phosphor layers, green phosphor layers, and blue phosphor layers.

In addition, when a phosphor paste, in which one of a red phosphor material, a green phosphor material, and a blue phosphor material is mixed with a solvent and a binder, is disposed in the discharge cell 126, the phosphor paste is applied on the front surface of the rear dielectric layer 123 and on at least some parts of the side surfaces of the horizontal and vertical barrier ribs 130a and 130b in the discharge cells 126, and dried and baked to form the phosphor layer 125.

In addition, the red phosphor material can be (Y,Gd)BO₃:Eu³⁺, the green phosphor material can be Zn₂SiO₄:Mn²⁺, and the blue phosphor material can be BaMgAl₁₀O₁₇:Eu²⁺.

A discharge gas including at least one of a group of gases consisting of Xe, Ne, He, Ar, and a mixture gas including two or more of the previous gases is contained within the discharge cells 126. Since the discharge cells 126 are in a vacuum state (0.5 atm), the vacuum pressure of the discharge gas pressurizes the rear substrate 121, and the pressure is supported by the barrier ribs 130.

In addition, the front panel 110 and the rear panel 120 can be attached by an attachment element, such as frit glass, applied on edges of the front and rear panels 110 and 120.

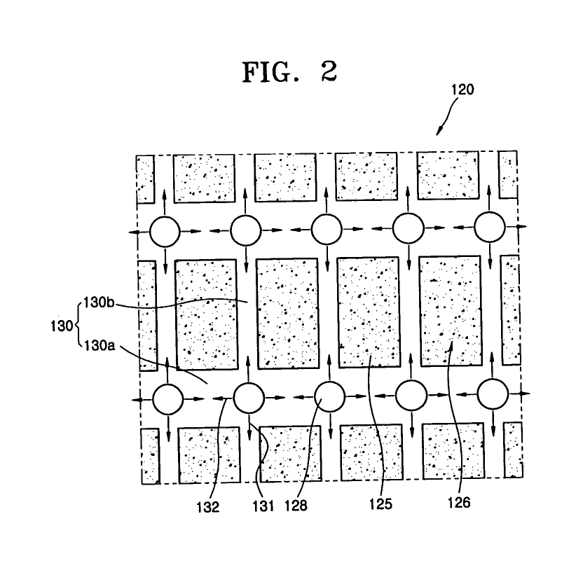

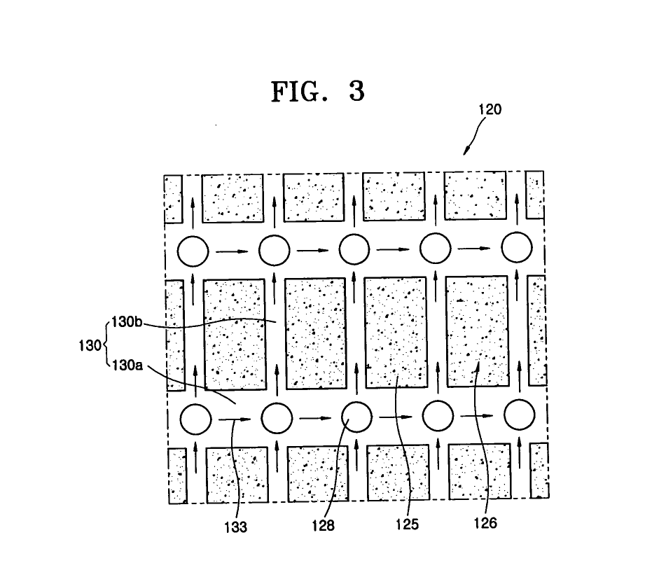

Referring to FIGS. 2 and 3, the function of the recesses 128 formed on the PDP 100 according to the current embodiment of the present invention is as follows.

In FIG. 2, the directions of barrier rib contractions 131 and 132 that occur during the baking process for fabricating the barrier ribs 130 are illustrated. When the barrier rib material is patterned using the above process and shapes of the barrier ribs are formed, the baking process is performed in order for the barrier ribs 130 to have a predetermined strength.

The baking process is performed by heating the rear panel 120 in a baking furnace, the highest temperature of which is slightly higher than the burning temperature of the barrier rib material, that is, about 400˜600° C. In addition, volatile material included in the barrier rib material is volatilized during the baking process, and thus, the barrier rib material contracts at a predetermined contraction rate.

When the barrier ribs 130 contract due to the baking process, the lengths of the barrier ribs 130 are reduced along the contraction directions 131 and 132 facing the center portion of the PDP 100 as illustrated in FIG. 2, and thus, compressive stress is generated by the contraction. The compressive stress applied to the barrier ribs 130 before baking increases gradually from the center of the PDP toward the edges of the panel 100, and accordingly, a greater compressive stress is applied to the barrier ribs 130 disposed on outer portions of the PDP 100. Therefore, the highest amount of compressive stress is applied to the outermost barrier ribs 130.

The highest amount of compressive stress which is applied to the outermost portion of the PDP 100 generates a maximum rotating moment at the outermost portions of the barrier ribs 130, and accordingly, the barrier rib 130 rises or separates from the substrate.

When the front panel 110 and the rear panel 120 are attached to each other to fabricate the PDP 100, if the rising occurs at the outermost portions of the barrier ribs 130, the attaching at the outer portions of the PDP 100 cannot be performed exactly due to the risen barrier ribs 130. Therefore, a gap occurs between the barrier ribs 130 and the front panel 110 along the edge of the PDP 100.

Therefore, when the PDP 100 is driven, shockwaves generated in the discharge cells 126 located in the outer portions of the PDP 100 or center portions of the PDP 100 are transferred to the barrier ribs 130 at the outermost portion of the PDP 100 along the barrier ribs 130. Accordingly, due to the gap of the risen barrier rib 130, the outermost barrier rib 130 and the front panel 110 that are separated from each other collide with each other periodically, thereby generating noise.

In addition, when the shockwaves hit the outermost barrier ribs 130 of the PDP 100, the barrier ribs 130 vibrate due to the separation of the barrier ribs 130 from the rear panel 120. In addition, the barrier rib 130 periodically hits the rear panel 120, and the noise becomes louder.

Therefore, it is very important to minimize the contraction of barrier ribs 130 during the baking process in order to reduce the noise generated by the PDP 100. Therefore, the PDP 100 according to the current embodiment of the present invention includes the recesses 128 formed on the front surface of the barrier ribs 130, more preferably, at the cross portions 130aa where the horizontal barrier ribs 130a and the vertical barrier ribs 130b intersect.

Referring to FIG. 2, when the barrier ribs 130 are baked after patterning the barrier ribs 130, the barrier ribs 130 contract along the contraction directions 131 and 132. The compressive stress caused by the contraction is applied to all of the barrier ribs 130, and thus, the compressive stress is also applied to the recesses 128.

When the compressive stress occurs around the recesses 128, the recesses 128 are expanded by the compressive stress. Consequently, the expansion of the recesses 128 compensates for the reduced lengths of the barrier ribs 130.

Therefore, the effect of the shortened barrier ribs on the outer portions of the PDP 100 can be lessened by the expanded recesses 128, and consequently, the rotating moments formed on the outer barrier ribs 130 can be reduced. Therefore, the bulging and separation of the barrier ribs 130 can be minimized.

Since the rising and separation of the barrier ribs 130 on the outer portions of the PDP 100 are minimized, collisions of the front panel 110 with the rear panel 120 due to the vibration can be reduced and the noise generated by the PDP 100 can be greatly reduced.

If the width of the horizontal barrier ribs 130a is greater than that of the vertical barrier ribs 130b, the horizontal barrier ribs 130a contract more than the vertical barrier ribs 130b. Therefore, it is preferable that the recesses 128 are formed on the front surface of the horizontal barrier ribs 130a.

In addition, since the horizontal barrier ribs 130a and the vertical barrier ribs 130b both contract, it is preferable that the recesses are formed on the cross portions 130aa where the horizontal barrier ribs 130a and the vertical barrier ribs 130b intersect.

In addition, since the compressive stress applied to the recesses 128 is uniform around the recesses 128, cross-sections of the recesses 128 are circular or oval during the fabrication process regardless of the initial shape thereof. However, if the lengths of the barrier ribs 130 are too short, the compressive stress cannot be sufficiently applied to the recesses 128, and thus, the cross-sections of the recesses 128 can have a polygonal shape.

Referring to FIG. 3, the other function of the recesses 128 for reducing noise is as follows. When the baking process is performed after patterning the barrier ribs 130, the recesses 128 can reduce the amount of contraction of the barrier ribs 130 to reduce the noise as described above.

However, even when the baking process is performed before patterning the barrier ribs 130 or if the baking process is not performed at all, the recesses 128 can greatly reduce the noise of the PDP 100.

In more detail, the rising and separation of the barrier ribs 130 occurring in the outermost barrier ribs 130 account for a large amount of the noise generated in the PDP 100. If the baking process is not performed, the rising and separating phenomena of the barrier ribs are greatly reduced.

However, there are a lot of well-known and unknown defective features in various processes for producing the barrier ribs 130, thereby generating the rising and separation of the barrier ribs 130 at the outermost barrier ribs 130 and on other portions of the barrier ribs.

According to the current embodiment of the present invention, when the shockwaves generated in the discharge process are transferred along the barrier ribs 130, the barrier ribs 130 at the defective portions periodically collide with the front substrate 111 or the rear substrate 121, thereby generating noise. Therefore, if the shockwaves generated in the discharge process collide with the barrier ribs 130, the vibrations generated due to the collisions should not be allowed to be transferred along the barrier ribs 130 to reduce the noise.

In more detail, referring to FIG. 3, when the shockwaves are generated from the discharge cells 126 due to the discharge process, the shockwaves collide with the barrier ribs 130, and accordingly, the vibrations are transferred in a proceeding direction 133 along the barrier ribs 130.

However, when the recesses 128 are formed on the front surface of the barrier ribs 130, the vibrations are prevented by the recesses 128 to some degree and are reflected, thereby generating a destructive interference with upcoming vibration and reducing the vibration. In addition, the vibration is reduced by the recesses 128 that perform as discontinuous surfaces, and consequently, the reduction of vibration results in the reduction of noise of the PDP 100.

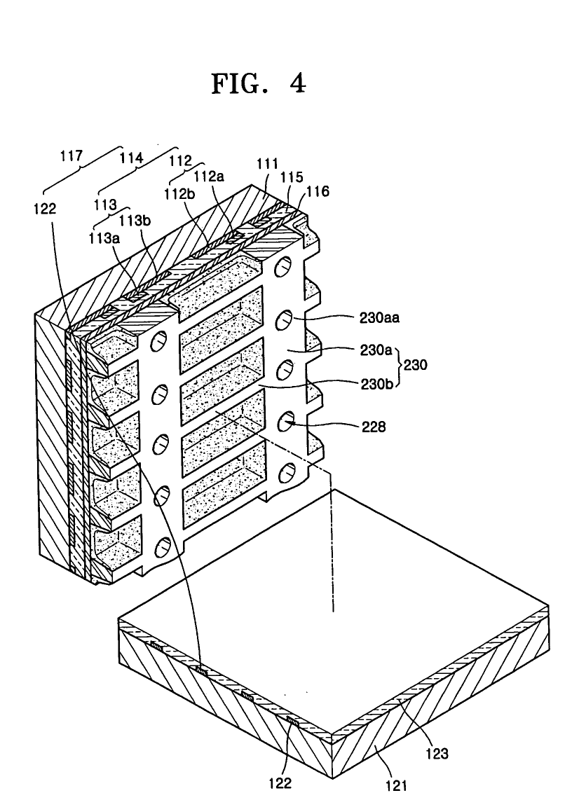

Referring to FIG. 4, a PDP 200 according to a second embodiment of the present invention will be described.

A difference of the current embodiment of the present invention from the previous embodiment is that a plurality of recesses 228 are formed on a rear surface of a plurality of barrier ribs 230.

In the current embodiment of the present invention, the sustain electrodes 114 are disposed on a front substrate 111. However, the present invention is not limited thereto. That is, the sustain electrodes 114 can be supported and disposed on a rear substrate 121, and a plurality of address electrodes 122 can be supported and disposed on the front substrate 111.

The barrier ribs 230 can include a plurality of horizontal barrier ribs 230a and a plurality of vertical barrier ribs 230b as in the previous embodiment, and the recesses 228 can be formed in the rear surface of the horizontal barrier ribs 230a, and more preferably, can be formed on cross portions 230aa where the horizontal barrier ribs 230a and the vertical barrier ribs 230b intersect.

According to the PDP of these embodiments of the present invention, the contraction of barrier ribs during the baking process can be reduced to minimize the rising and separation of the barrier ribs, and thus, the noise generated when driving the PDP can be reduced.

In addition, the vibration of the barrier ribs generated by the shockwaves generated during the discharge process can be compensated for, and thus, the noise generated when driving the PDP can be reduced.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A Plasma Display Panel (PDP), comprising:
a front substrate and a rear substrate facing each other;
a plurality of barrier ribs arranged between the front substrate and the rear substrate, defining a plurality of discharge cells where a discharge occurs, and including a plurality of recesses;
a plurality of electrodes corresponding to the discharge cells and adapted to generate the discharge;
a plurality of phosphor layers arranged within the discharge cells; and
a discharge gas contained within the discharge cells.

2. The PDP of claim 1, wherein the recesses of the barrier ribs are arranged in surfaces of the barrier ribs facing the front substrate.

3. The PDP of claim 1, wherein the recesses of the barrier ribs are arranged in surfaces of the barrier ribs facing the rear substrate.

4. The PDP of claim 1, wherein the barrier ribs include horizontal barrier ribs arranged in a first direction, and vertical barrier ribs arranged in a second direction crossing the horizontal barrier ribs.

5. The PDP of claim 4, wherein a width of the horizontal barrier ribs is greater than a width of the vertical barrier ribs.

6. The PDP of claim 4, wherein the recesses are arranged in the horizontal barrier ribs.

7. The PDP of claim 4, wherein the recesses are arranged in cross portions of the horizontal barrier ribs where the horizontal barrier ribs and the vertical barrier ribs intersect.

8. The PDP of claim 1, wherein a cross-section of each recess is circular shaped with respect to a surface parallel to the front substrate.

9. The PDP of claim 1, wherein a cross-section of each recess is oval shaped with respect to a surface parallel to the front substrate.

10. The PDP of clam 1, wherein the electrodes include a plurality of sustain electrodes extending in a predetermined direction, and a plurality of address electrodes extending to cross the sustain electrodes.

11. The PDP of claim 10, wherein the sustain electrodes are supported by the front substrate, and the address electrodes are supported by the rear substrate.

12. The PDP of claim 11, further comprising:
a front dielectric layer supported by the front substrate and adapted to cover the sustain electrodes; and
a rear dielectric layer arranged on the rear substrate and adapted to cover the address electrodes.
